(19) United States
(12) Patent Application Publication
(10) Pub. No.: US 2009/0015019 A1
(43) Pub. Date: Jan. 15, 2009

(54) Lateral Wind Turbine

(76) Inventor: Robert J. Donaghey, Vista, CA (US)

Correspondence Address: MINTZ, LEVIN, COHN, FERRIS, GLOVSKY AND POPEO, P.C;ATTN: PATENT INTAKE CUSTOMER NO. 64046, ONE FINANCIAL CENTER, BOSTON, MA, 02111, US

(21) Appl. No.: 12/171,215

(22) Filed: Jul. 10, 2008

Related U.S. Application Data
(60) Provisional application No. 60/959,082, filed on Jul. 10, 2007.

(51) Int. Cl. F03D 9/00; F03D 3/00

(52) U.S. Cl. 290/55

(57) ABSTRACT

A lateral wind turbine is presented. The lateral wind turbine includes an elongated rod that rotates about a rotation axis through the center of the rod. The lateral wind turbine further includes a number of blades radiating out from the rod in an arrangement along the length of the rod to capture wind energy. A wind collector, preferably in the form of a cylinder, at least partially houses and supports the elongated rod and the plurality of blades to allow rotation of the elongated rod about the rotation axis. The wind collector has an inlet an outlet, and at least one airflow guide at the inlet, to guide the wind energy through the plurality of blades at least partially transverse to the rotation axis.

### CROSS REFERENCE TO RELATED APPLICATION

This application claims the benefit under 35 U.S.C. Section 119(e) of a provisional application U.S. Ser. No. 60/959,082, entitled “Lateral Wind Turbine,” filed Jul. 10, 2007 (Attorney Docket No. 36730-501PRO), which is incorporated by reference herein.

### BACKGROUND

This document relates to alternative energy sources, and more particularly to a wind turbine system and method.

Modern society is reliant on electricity, yet today's electricity generation and delivery infrastructures are straining to meet an ever-escalating demand for power. In some regions, there is insufficient generator capacity to meet peak electricity demand. Many consumers have recently experienced periodic rolling blackouts, and many business fear not having a reliable source of needed power. The energy that powers homes, workplaces, public spaces, schools, etc., is typically generated by large-scale power plants and then transmitted over great distances to its end-use. The planning, permitting and construction of large central power generation plants can take years to implement amid substantial opposition and environmental concerns. The existing power transmission and distribution grid is aging and cannot carry all the electricity needed by consumers. Further, high voltage transmission lines are costly to build, maintain and replace.

World energy consumption continues to climb, despite some calls for energy conservation. Most energy currently consumed is derived from fossil fuels, which are primarily hydrocarbons such as coal and petroleum and natural gas. However, the thirst for energy from fossil fuels is a major cause of regional and global conflicts, and has contributed to enormous emissions of carbon dioxide into the Earth's atmosphere. Such emissions are commonly referred to as “greenhouse gases” and are thought to be a major factor in global warming and all of its potentially dire effects.

In the wake of modern society's addiction to and over-reliance on fossil fuels, several movements have been spawned that focus on renewable energy sources to both meet global energy needs and to reduce greenhouse gas emissions. Renewable energy is widely believed to be able to replace fossil-fuel based electricity to reduce toxic atmospheric and greenhouse gas emissions, without the geopolitical tensions that accompany international fossil-based fuel extraction and transportation.

Two prominent renewable energy sources are solar power and wind power. Solar power involves converting sunlight into electricity using arrays of photovoltaic cells, or harnessing heat from sunlight for passive heating systems or driving large steam-based turbines. While there is no shortage of a continuous supply of solar-derived energy, the infrastructure required to harness solar energy is considerable. Photovoltaic solar panels occupy a large amount of space, are very expensive to make, install and maintain, and presently are of limited efficiency.

Wind power is in general more cost effective and takes up less space than solar power. Wind power includes the conversion of wind energy into electricity using a wind turbine. Wind energy can be converted into electrical current by the use of an electrical generator that is driven by the rotation of turbine blades. Wind energy is plentiful, renewable, widely distributed, and clean. Although wind is at times intermittent and of variable force, such qualities usually pose no problem at its current penetration levels.

Wind power is typically generated from massive, large-scale wind farms for national electrical grids. These wind farms are sited in remote, unpopulated regions such as in mountains, the desert, and across a large body of water such as the ocean. While some small, individual turbines exist for providing electricity to rural residences or grid-isolated locations, there are virtually no wind turbines near the buildings in which the vast majority of electricity is consumed.

The estimated “costs” of wind energy per unit of production is generally based on average cost per unit, which incorporates the cost of construction, borrowed funds, return to investors (including cost of risk), estimated annual production, and other components. The production cost of wind energy is about one-fifth what it was two decades ago, however installation costs have increased significantly in the past few years. The cost of wind power also depends on several other factors, such as installation of power lines from the wind farm to the national grid and the frequency of wind at the site in question. Single and small cluster turbine farms result in higher costs per kilowatt hour. Costs include installation costs, operation, and maintenance costs. Transmission costs further add to the overall price.

Costs vary in proportion to wind turbine size, which is also proportional to amount of electricity produced. However, large wind turbines, for various reasons, must be located remotely from the eventual user of the electricity. Transmission of electricity results in loss, on average from 40-50%. Thus, conventional wind power systems are inefficient and consume vast resources.

### SUMMARY

This document presents a lateral wind turbine having a shape and profile that is suitable for being mounted to edges of a structure, such as corners and rooflines of a building, for example. In one aspect, the lateral wind turbine can be provided as a set on the structure, a portion of the set always being aligned toward the direction of the wind. In another aspect, one or more lateral wind turbines convert wind energy to electric power for local storage and/or use within the structure, thereby dispensing with the need for elaborate, costly and inefficient power distribution systems. The lateral wind turbines also enable a structure to capture wind energy at a time it most occurs—through the night hours.

The lateral wind turbines disclosed herein can contribute to lessening carbon output and greenhouse gasses, lowering pollution from the burning of fossil fuels, and lowering average consumers' energy bills by taking advantage of an abundant, renewable and clean source of energy. Further, the form and function of the lateral wind turbines disclosed herein allow them to be deployed unobtrusively and easily, and being efficiently integrated into the energy system of a structure. The lateral wind turbines are environmentally friendly, safe to living organisms such as humans, birds, etc., and cost effective to manufacture and install.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a side view of a rotor assembly for a lateral wind turbine.

FIG. 2 is a frontal view into the rotation axis of the rotor assembly.

FIG. 3 is side view of a housing for a lateral wind turbine.

FIG. 4 is a side view of a lateral wind turbine system.

FIG. 5 illustrates a lateral wind turbine in operation.

FIG. 6 is a perspective view of two or more lateral wind turbines connected in series along an edge of a structure.

FIG. 7 is a schematic diagram of an energy system including one or more lateral wind turbines.

FIG. 8 is an exploded plan view of one implementation of a lateral wind turbine system.

FIG. 9 is a side view of one implementation of a lateral wind turbine system.

FIG. 10 shows a lateral wind turbine system mounted to an edge of a structure.

FIG. 11 is an exploded view of another implementation of a lateral wind turbine system.

FIGS. 12A and 12B are exploded views of a bearing system for a lateral wind turbine.

FIGS. 13A and 13B are exploded views of another implementation of a bearing system.

FIG. 14 is an exploded view of a gear and generator assembly.

FIG. 15 is a side view of a gear and generator assembly.

FIG. 16 shows an alternative implementation of a blade.

FIG. 17 illustrates a magnetic coupling system.

FIG. 18 illustrates a physical coupling system.

FIG. 19 is a side view of a collector for a lateral wind turbine.

FIGS. 20A-D illustrate various operational modes of an airflow guide for a wind turbine air collector.

FIG. 21 is a plan view of a lateral wind turbine with airflow guide.

FIG. 22A is a frontal plan view and FIG. 22B is a rear plan view of a lateral wind turbine having multiple airflow guides at an inlet to a collector.

FIG. 23 illustrates an alternative implementation of a lateral wind turbine as mounted to a structure.

Like reference symbols in the various drawings indicate like elements.

### DETAILED DESCRIPTION

This document describes a lateral wind turbine: a wind turbine that captures wind energy arriving at a rotor assembly at an angle that is transverse to an axis of rotation of the rotor assembly. The lateral wind turbine is preferably elongated, making it suitable for installation along the edges of a building, such as eaves, rooflines, and corners, where wind reaches its highest velocity after accumulating and flowing along the sides or roof of the building. Multiple lateral wind turbines can also easily be arranged linearly, or provided in an array, for compounding efficient electricity generation.

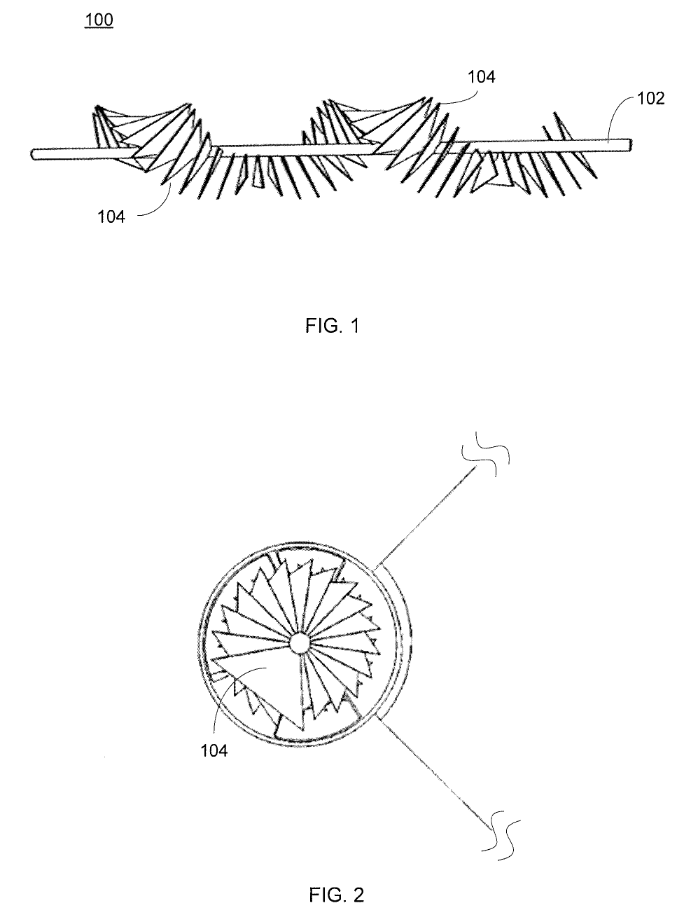

FIG. 1 and FIG. 2 illustrates a rotor assembly 100 for a lateral wind turbine that can be mounted to a structure, particularly edges and/or sides of a solid surfaced building. The rotor assembly 100 includes a rod 102 that rotates about a rotation axis R, and a number of blades 104 radiating out from the rod along the rotation axis or length of the rod. The blades 104 are arranged and adapted to capture wind energy that is primarily transverse to the rotation axis R to cause rotation of the rod 102. The rotor assembly 100 is driven by wind energy having a directional force that, for optimum performance, is perpendicular or transverse to an axis of rotation of the wind turbine. However, the lateral wind turbine can be rotated by wind energy having a directional force of +/−45 degrees from the perpendicular angle to its axis of rotation to still be effective.

The rod 102 is preferably an elongated, narrow and/or cylindrical structure, although the rod 102 can also be implemented as barrel-shaped cylindrical or tetrahedral structure with an outer surface that has airflow passageways and fins or blades for capture wind energy. In still yet other implementations, the rotor assembly may be formed of a set of interconnected blades that rotate symmetrically about the rotation axis R.

In some implementations, the rod 102 and blades 104 are formed of a unitary piece of material. The rod 102 and/or blades 104 preferably formed of a rigid material such as ABS plastic, steel, aluminum, titanium, or the like. In other implementations, the blades 104 are formed of a different material than the rod 102. In such implementations, the rod 102 can be made of a denser, heavier material than the blades 104 to allow the rod 102 to develop rotational momentum as the blades 104 capture wind energy to rotate the rod 102. The rod 102 and blades 104 are preferably formed of a water-resistant and non-corroding material that can also withstand swings in temperature, humidity and pressure.

In an preferred exemplary implementation, one or more of the blades 104 are triangular, with a straight distal side, and occupying 5 to 95 degrees of area around the rod 102 with reference to the rotation axis R, as shown in FIG. 2 which is a view of a rotor assembly 100 into the rotation axis R. The faces of the blades 104 can be slightly curved to maximize both wind energy capture by the blades 104 and airflow through the rotor assembly 100. The blades 104 may be of any shape, however, and can have one or more apertures for increasing airflow and/or free movement. The one or more apertures can be dynamically adjustable. The rod 102 can have a length from 6 inches to 10 feet, and preferably 2 to 5 feet, although other lengths are possible. The blade arrangement, as exemplified in FIG. 2, can have a cross-sectional diameter from 2 inches to 2 feet, and preferably 6 to 12 inches, although other lengths are possible. Any frame or housing 110 around the rotor assembly 100 should be spaced apart from the distal ends of the blades 104, which define the cross-sectional diameter.

In a preferred implementation, the blades 104 radiate from the rod 102 in a helical arrangement, as substantially shown in FIG. 1. Other radiating arrangements are possible, as well as any angular position or pitch of a blade 104 with respect to the rod 102. The blades 104 may also be individually or collectively movable to any angle or pitch, to dynamically adjust to lateral wind conditions having a primary direction that is transverse to the rotation axis R. The arrangement and orientation of the blades 104 should be optimized to both capture wind energy on one half of the rotor assembly 100 on either side of the rod 102, while also allowing airflow through that same half. Accordingly, the rotor assembly 100 efficiently uses airflow over one side or half-cylinder yet inhibits air pressure buildup and turbulence on the blades 104 and within the rotor assembly 100.

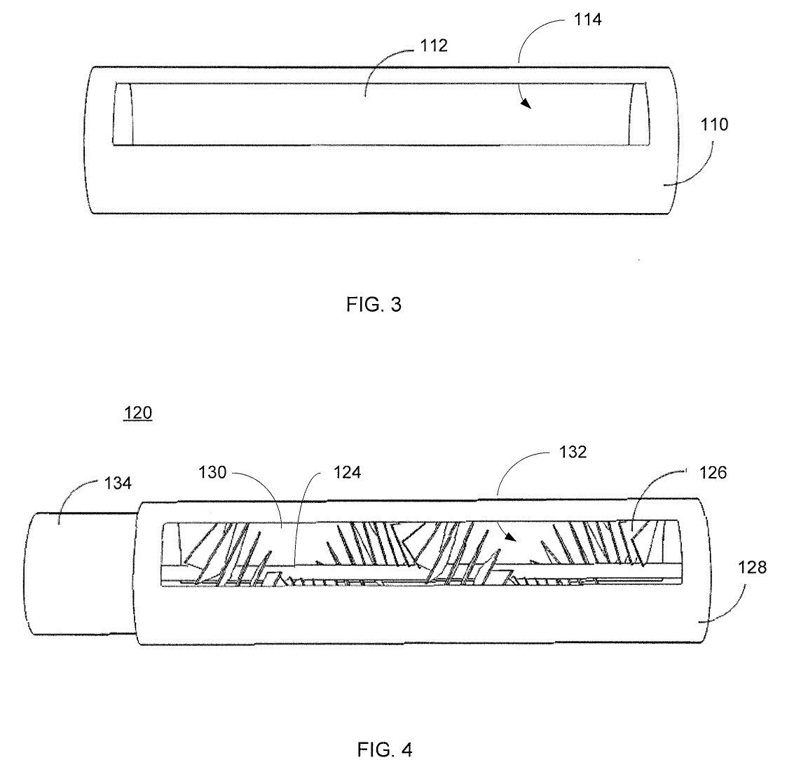

FIG. 3 illustrates a housing 110 for a lateral wind turbine. The housing 110 includes an inlet 112 and an outlet 114. The housing 110 is preferably cylindrical, especially on the inner surface, although can have any shape, particularly on the outer surface. For instance, the housing 110 may be elliptical, or have any other curved or angled cross section. The housing 110 may include any of a number of connectors for connecting to a structure, such as the edges and/or sides of a building. The inlet 112 and outlet 114 preferably occupy a major portion of the length of the housing 110, and from 45 to 90 degrees of angular width along the outer surface. In some implementations, the outlet 114 is slightly wider than the inlet 112. Preferably, the inlet 112 and outlet 114 are formed on the same half, or nearly the same half, of the housing 110 with reference to a plane that bisects the housing along the rotation axis R.

FIG. 4 illustrates a lateral wind turbine 120 in accordance with a preferred exemplary implementation, in which a turbine assembly 122 having a rod 124 and a number of blades 126, substantially as described with reference to FIGS. 1 and 2, is rotatably mounted in a housing 128. The housing 128 includes an inlet 130 and an outlet 132, which cooperate to allow air to flow over one half of the turbine assembly 122 so that blades 126 capture wind energy, convert the wind energy into kinetic energy, and rotate the rod 124.

The rotating rod 124 then drives a generator 134, which converts the rotational motion into electricity according to any of a number of energy generation mechanism and techniques. In other words, the rotor assembly made of blades 126 and rod 124 captures the kinetic energy of the wind and converts it into rotary motion to drive the generator 134. The generator 134 can be any conventional or specialized generator, and can include, without limitation, a low speed shaft, a gearbox, a high speed shaft, and an electrical generator having a rotator and a stator. Power from the rotation of the rotor is transferred to the generator through the power train, i.e. through the main shaft, the gearbox, and the high speed shaft. The generator 134 can also include an alternator for generating alternating current (A/C) electricity, as opposed to direct current (D/C) electricity of a standard generator.

The housing 128 can be mated to generator 134 according to any known mating techniques, or may be unconnected. The rod 124 or rotor assembly 122 can be rotatably mounted in the housing 128 by bearings or magnetic induction suspension systems, or any other low-friction or frictionless mechanism that allows as unrestricted rotation of the rod 124 or rotor assembly 122 as possible.

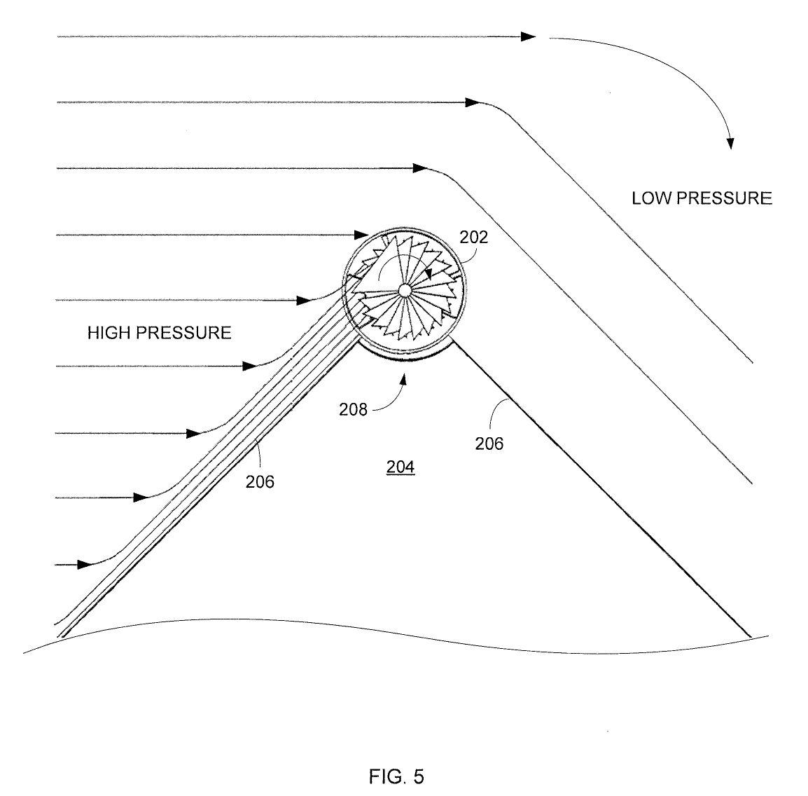

FIG. 5 illustrates an energy generation system 200 including a lateral wind turbine 202 mounted to a structure 204. The structure 204 preferably includes flat surfaces 206 that meet at an edge 208, such as a corner or a roofline, where the lateral wind turbine 202 is mounted. However, the lateral wind turbine 202 can also be mounted at any location along the flat surface 206, which can be straight or curved, of the structure 204. FIG. 5 provides a view of the lateral wind turbine 200 into the rotation axis R of the rotor assembly 210.

The arrows represent wind energy traveling in a direction toward and over a structure 204. Much of the wind energy usually meets the structure at an angle, toward the flat surface 206. The wind energy accumulates on the flat surface 206, its air pressure is increased, and is directed or pushed along the flat surface 206 where it reaches a higher velocity, and suitably the highest velocity, at the location on the structure 200 where the lateral wind turbine 202 is mounted. Airflow enters an inlet of the lateral wind turbine 202 to turn the blades and rotor, and exits an outlet of the lateral wind turbine 202. In some implementations, the outlet is larger than the inlet so as to not inhibit the airflow and to distribute the airflow on the opposite side of the inlet. Also, the blades and rotor may tend to cause turbulence and dispersion of the airflow on the opposite side of the rotor than the inlet, thus requiring a suitably-sized outlet.

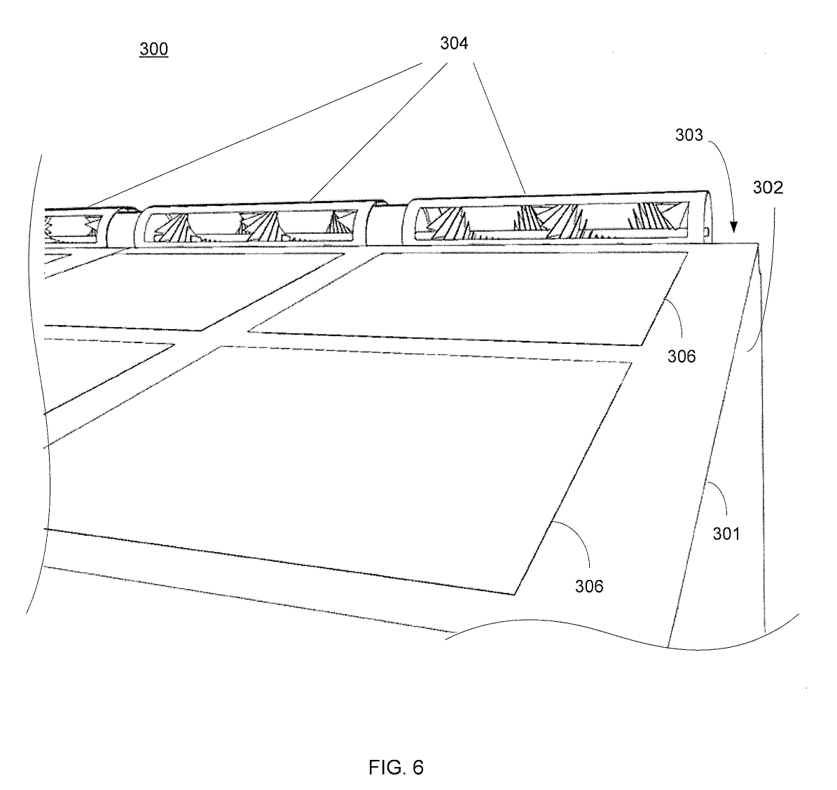

FIG. 6 illustrates an energy-efficient system 300. The energy-efficient system 300 uses features of a structure 302 to provide efficient, clean and renewable energy to the structure 302. The structure 302 can include one or more surfaces 301, such as a wall or a roof, etc., and one or more edges 303 such as a corner, roofline, etc. One or more lateral wind turbines 304 are mounted along one or more edges 303, respectively, to capture wind energy that has accumulated and accelerated along a surface 301 for conversion to electricity. One or more solar panels 306 are mounted on one or more respective surfaces 301 for capturing solar and/or thermal energy on the surface 301 for conversion to electricity and/or heat.

The lateral wind turbines 304 can be of the type substantially described above. The solar panels 306 can include any number of photovoltaic cells and/or semiconductors to generate electricity from sunlight. Further, since they usually provide a smooth top surface free of obstruction, the solar panels 306 can be arranged to maximize acceleration of wind energy across a surface 301 toward the one or more lateral wind turbines 304.

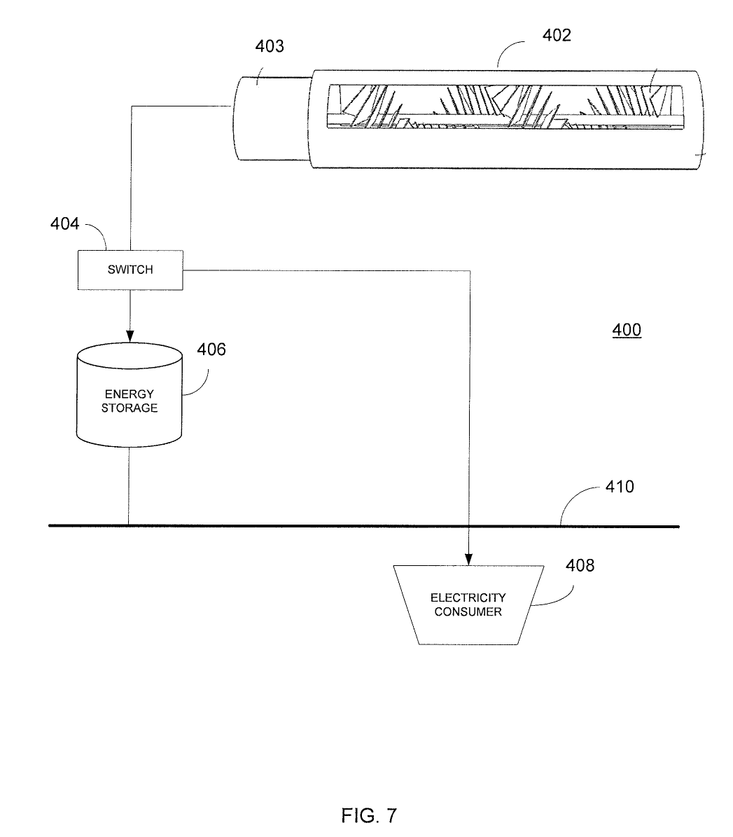

FIG. 7 illustrates an electric system 400, in which a lateral wind turbine 402, as substantially described above, includes a rotor-driven generator/alternator 404. The generator/alternator 404 generates electricity for either an energy storage 406, such as a battery or other storage mechanism, or the ultimate electricity consumer 408, which can be any electric device or mechanism. An electricity consumer 408 represents any device connected to, or connectable onto, a structure's electricity grid segment 410. A switch 404 can be used to either transmit electricity directly to the electricity grid segment 410 for delivery to one or more electricity consumers 408, or to the energy storage 406.

In an exemplary implementation, a set of lateral wind turbines of the type described above can be mounted on the edges of a structure such as a home, thereby having at least a portion of the lateral wind turbines being aligned toward the direction of the wind. In other words, if the wind changes direction, at least a portion of the lateral wind turbines on the structure receive direct wind. The lateral wind turbines can convert wind energy through the night hours, during which a substantial amount of wind occurs, into electricity for local storage in or near the structure. The stored electric energy can be used, among other alternatives, to power an electric vehicle, converted to heat to heat water for the following day, to power morning electricity needs such as hair dryers, coffee makers, lighting systems, etc. The lateral wind turbines may also be connected directly to such devices as an electric or hybrid vehicle, or other battery-powered device such as flashlights, air compressors, or backup generators.

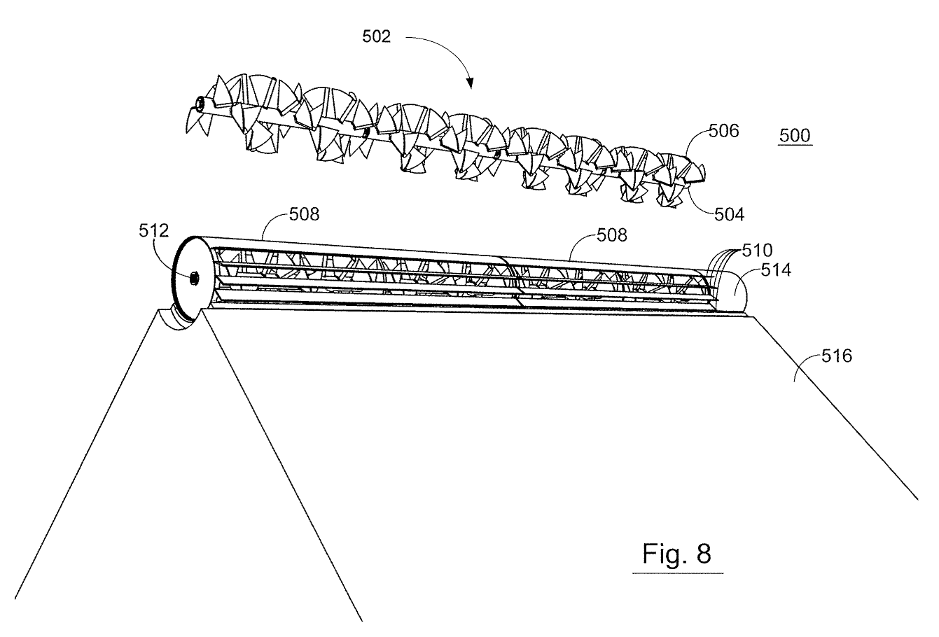

FIG. 8 is a partly exploded view of a lateral wind turbine system 500. The lateral wind turbine system includes a wind turbine assembly 502 that is formed of two or more wind turbine segments 503, and that is configured to spin by the force of wind. In one implementation, the wind turbine assembly 502 includes a rod 504 and a number of blades 506 extending radially from the rod 504 in a helical, double helical or other arrangement. The helical or double helical arrangement allows the wind turbine assembly 502 to provide sufficient space through which air can flow to not impede such air flow, while also taking advantage of a helical vortex force that is created as flowing air moves across each blade of the wind turbine assembly.

The blades 506 are preferably arranged symmetrically on the rod 504 to minimize or eliminate vibration of the wind turbine assembly 502 as it spins. The lateral wind turbine system 500 further includes a collector 508, i.e. a housing as described above that includes one or more air collection devices such as guides, channels, etc. in addition to an inlet and an outlet. The collector 508 forms at least a partial housing for the wind turbine assembly 502, and includes the inlet and outlet. The collector can be formed of metal, plastic such as PVC, polycarbonate, or any other rigid material.

In some implementations, the collector 508 includes one or more airflow guides 510 at the inlet for directing, collecting and/or accelerating air that flows along a surface of a structure 516 toward the lateral wind turbine system 500. Other airflow guides or exhaust flues can be arranged at the outlet, to channel and accelerate air out of the collector 508. The airflow guides 510 can be dynamically angled for optimizing collection of the wind, or closed in the event of a high-wind or other dangerous condition. Each airflow guide 510 can be curved or straight, and can extend out from one inch to several feet from the collector 508. The collector 508 also includes a bearing holder 512 that holds a bearing (not shown), to which the rod 504 is connected to the collector 508 at one end. The rod 504 is connected at its other end to a generator assembly 514. In some implementations, the generator assembly 514 includes a housing that can be shaped to correspond with the collector 508.

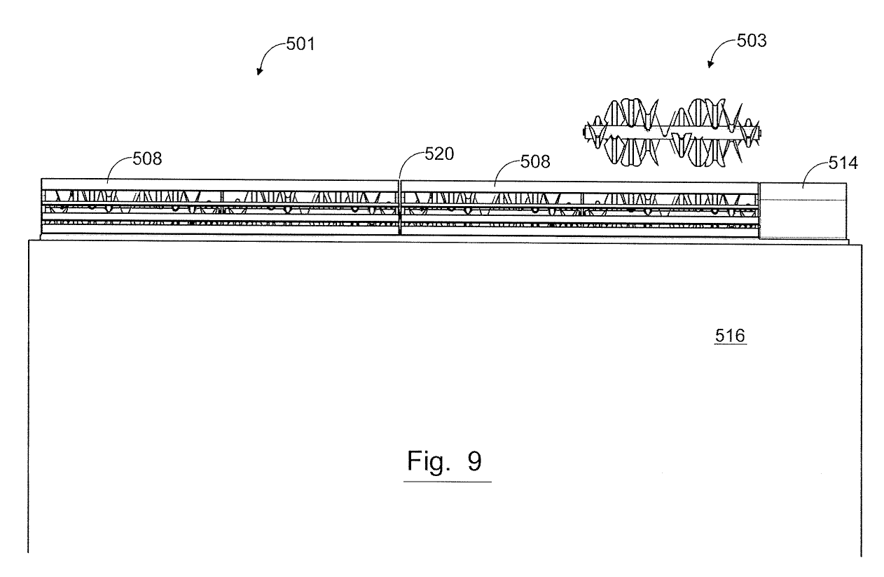

FIG. 9 is a front, partially exploded view of an implementation of a lateral wind turbine system 501, illustrating in particular the modularity of the lateral wind turbine system 501. In some implementations, as depicted in FIG. 9, the lateral wind turbine system 501 can include two or more wind turbine segments 503 coupled together in series, i.e. in a linear array, to rotationally power a generator 514 or alternator or the like. Further, two or more lateral wind turbine systems 501 can be installed in a linear array to a building or surface of a structure 516, such as a corner or roof of a building. The lateral wind turbine system 501 can include coupling interfaces 520 and/or 521 to couple two lateral wind turbine assemblies in serial collectors 508 or couple two wind turbine segments 503, respectively.

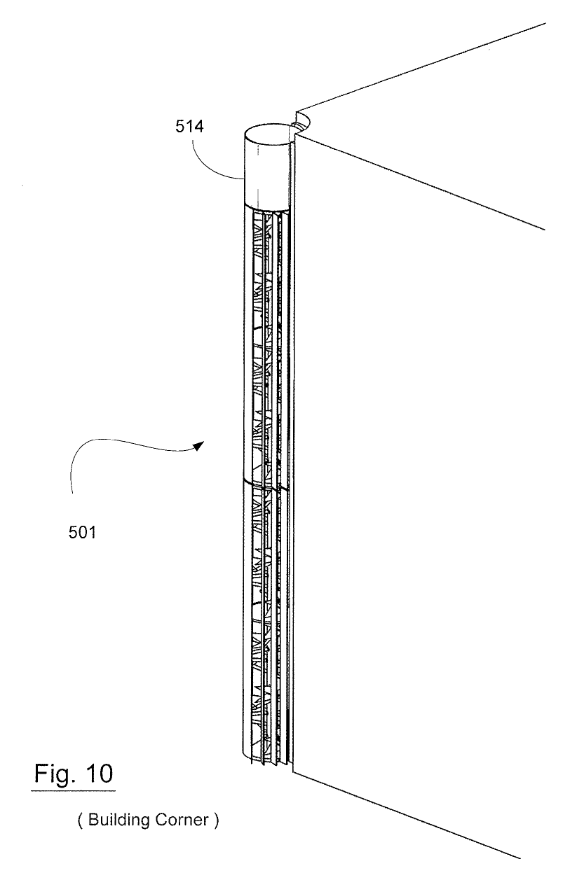

FIG. 10 depicts a lateral wind turbine system 501 that is vertically arranged and connected to a building corner, to take advantage of wind power that might occur around the corner of the building. The lateral wind turbine system 501 can be arranged such that the generator assembly 514 is positioned on top, however the generator assembly can also be positioned on the bottom of an installed lateral wind turbine system 501. In some implementations, the lateral wind turbine system 501 can be installed in a location as a standalone feature, or as part of another object such as a flag pole, light post, street sign, canopy support post, fence post, etc., or any other object having at least a cross-section diameter dimension that exceeds two inches.

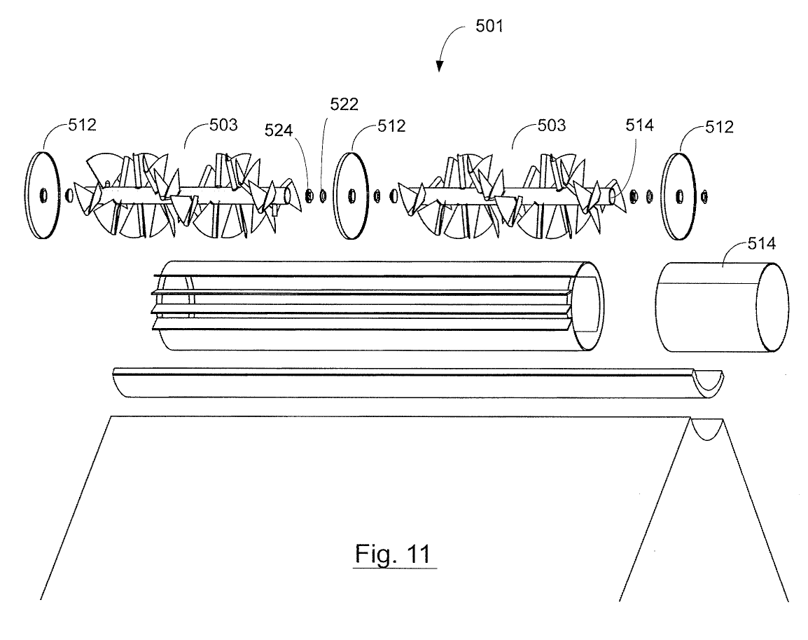

FIG. 11 is an exploded view of a lateral wind turbine system 501 and mounting mechanism 599 for mounting the lateral wind turbine system 501 to a structure 600 such as a roof of a house, corner of a building, etc. In some implementations, the lateral wind turbine system 501 includes a bearing holder 512 to hold one or more bearings and act as a divider between wind turbine segments 503, and between a wind turbine segment and the generator assembly 514. The bearing holder 512 is preferably planar except for a hole for receiving the bearings. The bearings can include an outer part 522 that is inserted into hole of the bearing holder, and an inner part 524 which is configured to be attached to the end of the rod 514 and which has a portion that fits into the outer part 522. The outer and inner parts 522 and 524 can be dry bearings. The mounting mechanism 599 can be an elongated member with a U-shaped cross section. Alternatively, the mounting mechanism can be any type of bracket assembly or hook to hold the lateral wind turbine system 501 in place at a desired location on the structure 600.

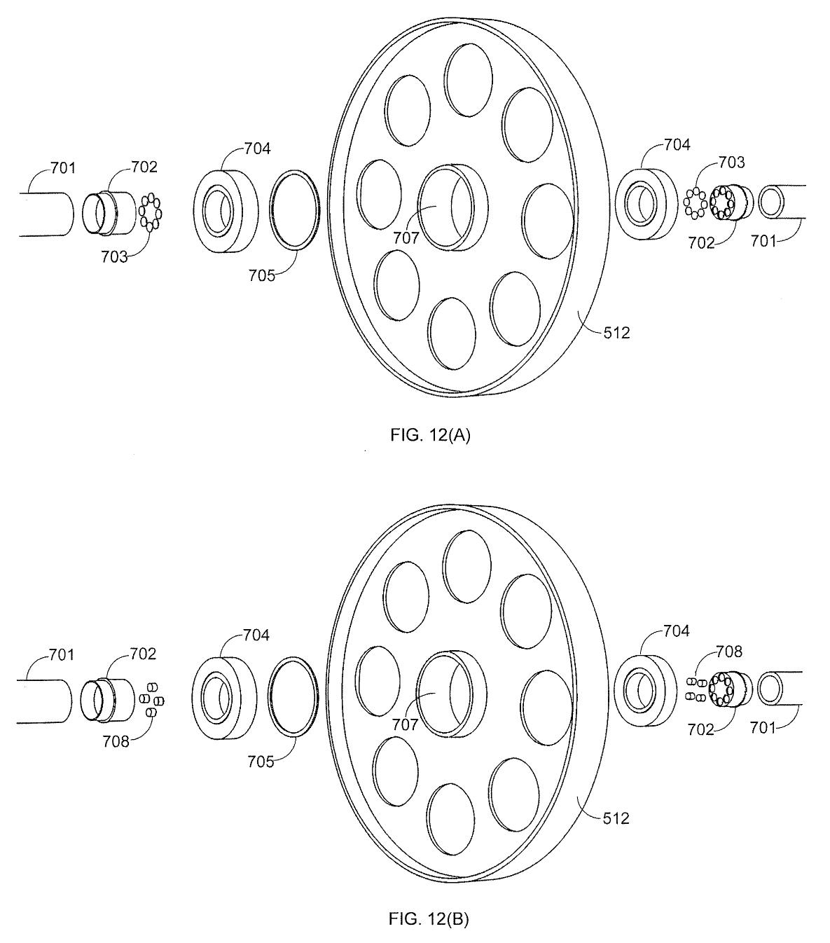

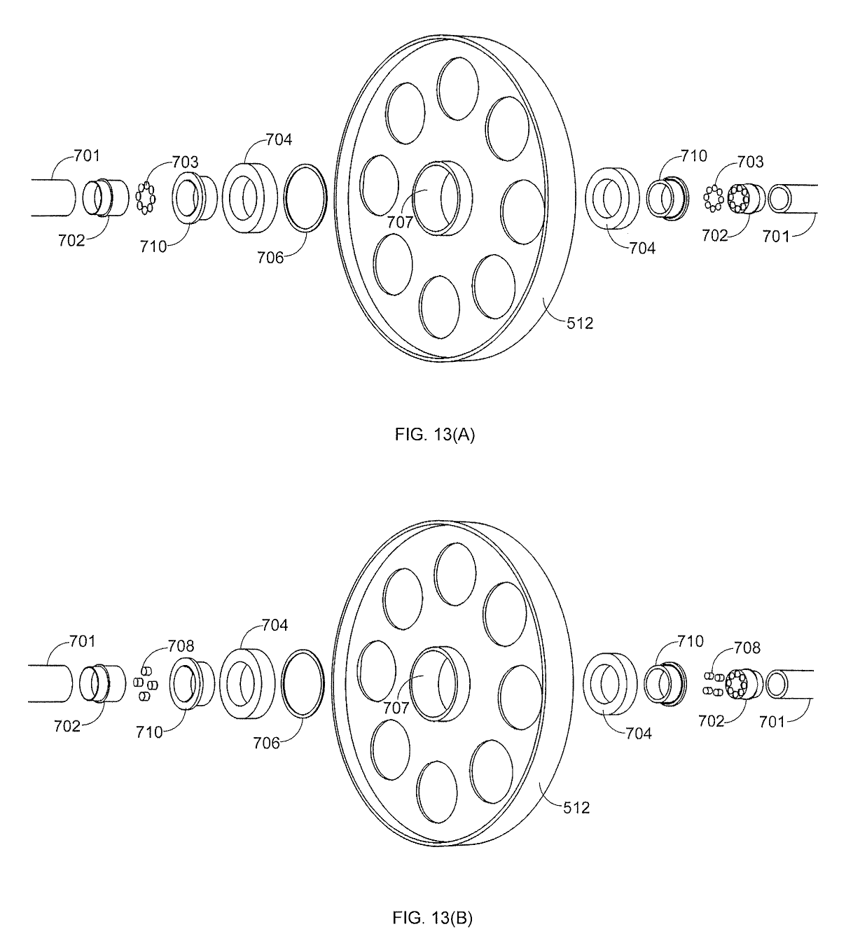

The bearings and bearing holder 512 are shown in more detail in FIGS. 12 and 13. FIG. 12A shows an implementation of a bearing holder 512 for magnetically coupling together two rods 701, or a rod 701 and a drive shaft of a generator, alternator, or the like. The bearing holder 512 includes a center channel 707. The center channel 707 is preferably cylindrical. A spacer 705 is placed inside the center channel 707, and has a thickness adapted for a predetermined level of magnetic coupling. For instance, a thicker spacer 705 yields less coupling.

On either side of the spacer is an outer bearing 704, a ring-like structure having an inner surface that is formed of a low-friction material, or which is coated with a low-friction substance. An inner bearing 702 has a first side that is adapted to connect to the rod 701, and a second side that includes a surface that interfaces with the inner surface of the outer bearing 704 and is likewise formed of a low-friction material or coated with a low-friction substance, for very low friction relative movement between the inner and outer bearings 702 and 703. An array of magnets 703 are provided in the face of the second side of the inner bearing 702, and which face corresponding magnets in the inner bearing 702 connected to the opposing rod 701 or drive shaft. The array of magnets 703 can be circular and including eight or more magnets. Alternatively, FIG. 12B shows an implementation having four magnets 708 for less magnetic coupling than is achieved in FIG. 12A.

FIGS. 13A and B show an alternative implementation of a bearing assembly, in which a spacer 706 is inserted into center channel 707 of a bearing holder 512, and an outer bearing 704 is inserted into the center channel 707 on either side of the spacer 706. The outer bearing 704 is a ring that accepts an intermediate bearing 710, which in turn has an inner surface that is formed of a low-friction material or coated with a low-friction substance. The intermediate bearing 710 receives the inner bearing 702, which, as described above, has either a circular array of magnets 703 or a spaced array of a fewer number of magnets 708, for more or less coupling energy, respectively.

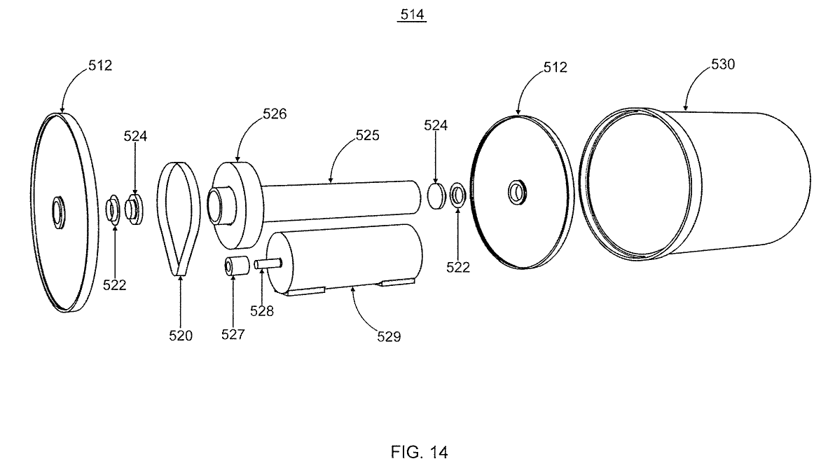

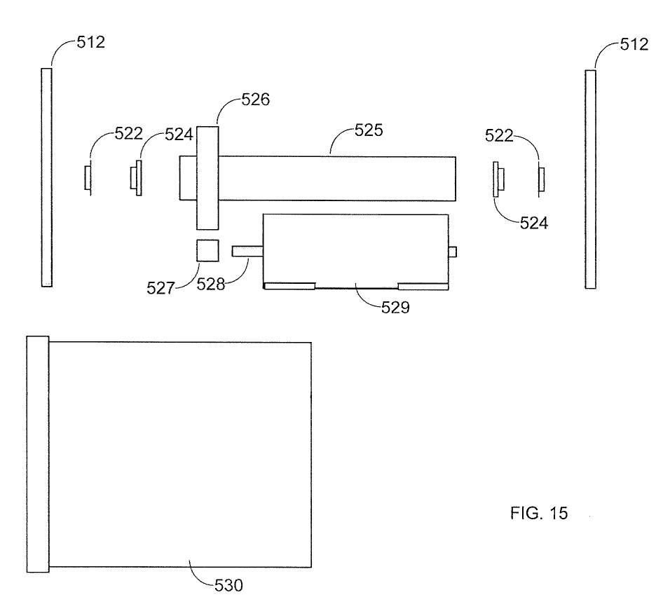

FIGS. 14 and 15 show an exploded plan view and a side view of an implementation of the generator assembly 514, respectively. The generator assembly 514 includes two bearing holders 512 for positioning a generator within generator housing 530 and for allowing rotation of drive shaft 525. The drive shaft 525 is coupled to bearing holders 512 by bearings, which as described above, can include outer part 522 rotatably coupled with inner part 524 as a dry bearing configuration. Other types of bearings can be suitably used.

The drive shaft 525 is driven by a rotating rod of one or more wind turbine segments or assemblies. In some implementations, the drive shaft 525 can include a cam 526 with gears to transmit motion from the drive shaft 525 to an input shaft gear 527 via drive belt 520, with a predetermined gear ratio from the drive shaft cam gear. More gears and different ratios can also be used. The input shaft gear 527 is coupled to input shaft 528 to generator 529. The generator 529 can be an electrical generator, alternator, or compressor, which can output energy or power to an energy consumer such as a battery or other storage device, an electricity source (such as the power grid), or appliance or other electricity consumer.

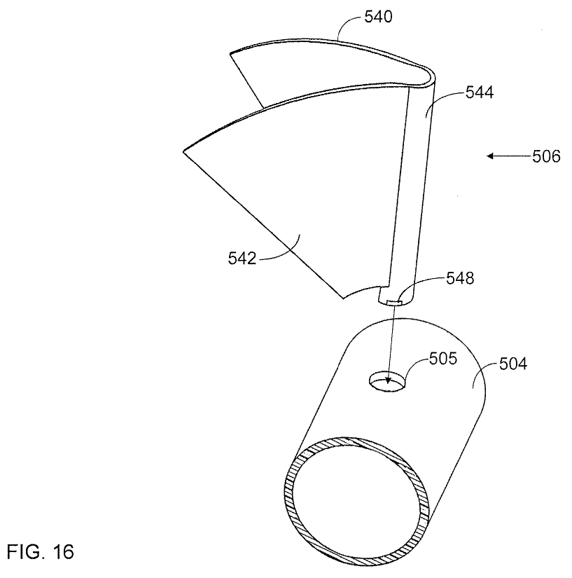

FIG. 16 is a side plan view of a blade 506 in accordance with one implementation, in which the blade 506 has a V-shaped blade surface. At least one flange 548 or other extension of the blade 506 is glued or snapped into aperture 505 in wind turbine assembly rod 504. Alternatively, the blade 506 can be connected to or mounted on a protruding member that extends out from the rod 504. In this implementation, the blade 506 includes a blade piece 540 having two fins 542 joined by a joining member 544. The joining member 544 can be an extension of, or otherwise part of, a unitary material from which the fins 542 are made, which can be thermally or magnetically bent and shaped to form the joining member 544 and two fins 542. Alternatively, the blade piece 540 can be injection molded into its shape.

The blade 506 can include one or more fins 542, and preferably two fins 542 that are of the same size. The blade 506 is connected to the rod such that the fins 542 are symmetrically arranged with respect to the rod 504. In other implementations, one or more blades 506 can be coupled to a lever or other mechanism that will rotate the blade 506, independently or as a group, from a first position to a second position that is 180 degrees different. Accordingly, the blades 506 can be configured to receive the maximum amount of air from a wind having any directional force.

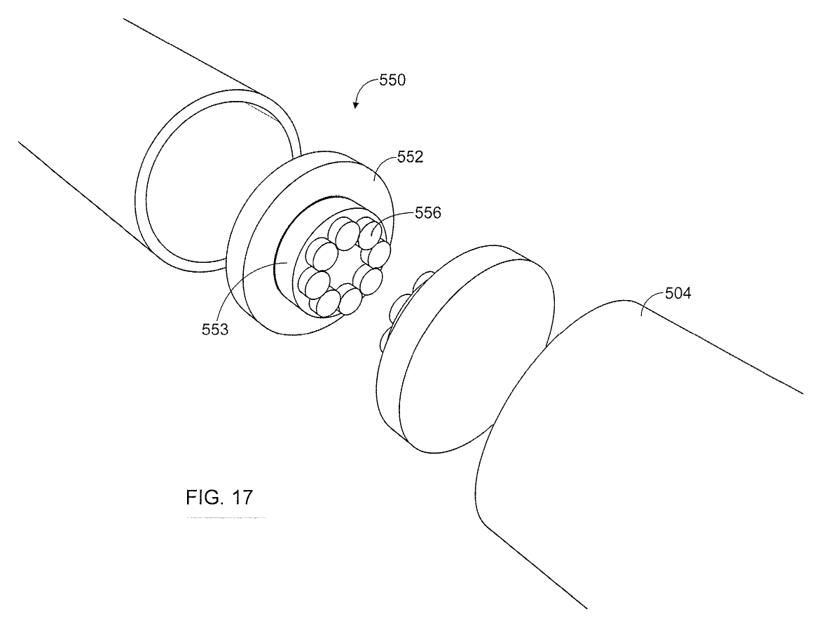

FIG. 17 illustrates one coupling implementation for bearing holder 512 described above, i.e. for coupling adjacent rods 504 or a rod 504 with a drive shaft of an alternator assembly. In this implementation, magnetic coupling is used, although physical coupling can also be used, such as via gears and belts, or direct drive coupling. Magnetic coupling allows a space to be placed between magnetic couplers to control the extent of coupling and torque transferred from one rod 504 to another. A magnetic coupler 550 is configured to be attached to rod 504, and includes an inner bearing 552 (such as inner part 524, which fits within a piece such as outer part 522 as described above) with a preferably circular array of magnets 556 extending out to juxtapose a similar array on an opposite-facing inner bearing 552. The magnets 556 can be arranged in a circle, preferably with alternating polarities, to provide a gearing effect between two opposing inner bearings 552. The outside edge 553 of inner bearing 552 can be coated with a slippery material.

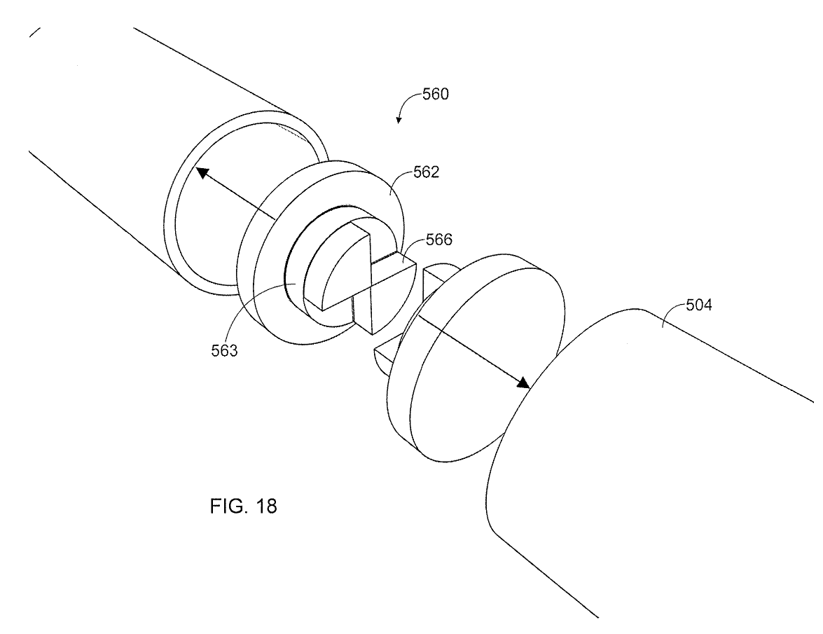

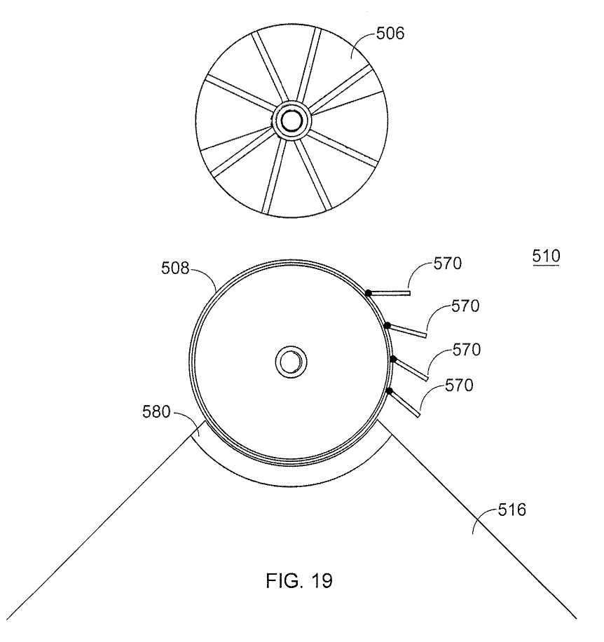

FIG. 18 shows physical coupling for bearing holder 512. A physical coupler 560 includes inner bearing 562. Inner bearing 562 includes protruding teeth 566 that are sized and adapted to interlock with a complementary set of teeth 566 on opposing inner bearing 562. In some implementations, teeth 566 can be made of resilient material, such as polyurethane, to absorb vibration that is caused by the transfer of rotational energy from one rod 504 to another rod 504 or drive shaft.

As discussed above, the lateral wind turbine system described herein is suitable for being mounted at the apex of a roofline or on the sides of a building, to capitalize on and capture wind that is accelerated by the “building effect,” i.e., the compression and acceleration of air as it travels along a building's flat surface toward and over an edge. To further capture this accelerated wind, a collector 508 is used. The collector 508 houses the wind turbine assemblies 506. Preferably, the collector 508 provides a clearance of up to two or more inches from the outer edge of the blades of the wind turbine assembly 506. The collector 508 has an inlet for receiving wind energy and directing it to the upper half of the wind turbine assembly. The collector 508 also has an outlet on the opposite side of the wind turbine assembly, to allow wind to escape and thereby turn the wind turbine assembly in the process. One or more air guides 570 are provided at least at the inlet. The air guides divert air flow to an optimum angle toward the blades, to present the air an such optimal angle and thereby impart maximum wind energy to the blades of the wind turbine assembly. In some implementations, the angle of each air guide 570 can be fixed, while in other implementations the angle is independently and dynamically configurable.

As shown in FIG. 19, a cushion 580 can be used to mount the collector 508 to the structure 516 at a corresponding channel provided in the apex or corner of the structure 516. FIG. 19 shows an alternative installation, in which a mount 582 is used to hold the cushion 580 or the collector 508 directly. In preferred implementations, the lateral wind turbine system is installed with the wind turbine assembly already mounted in the collector and connected to a generator assembly or the like.

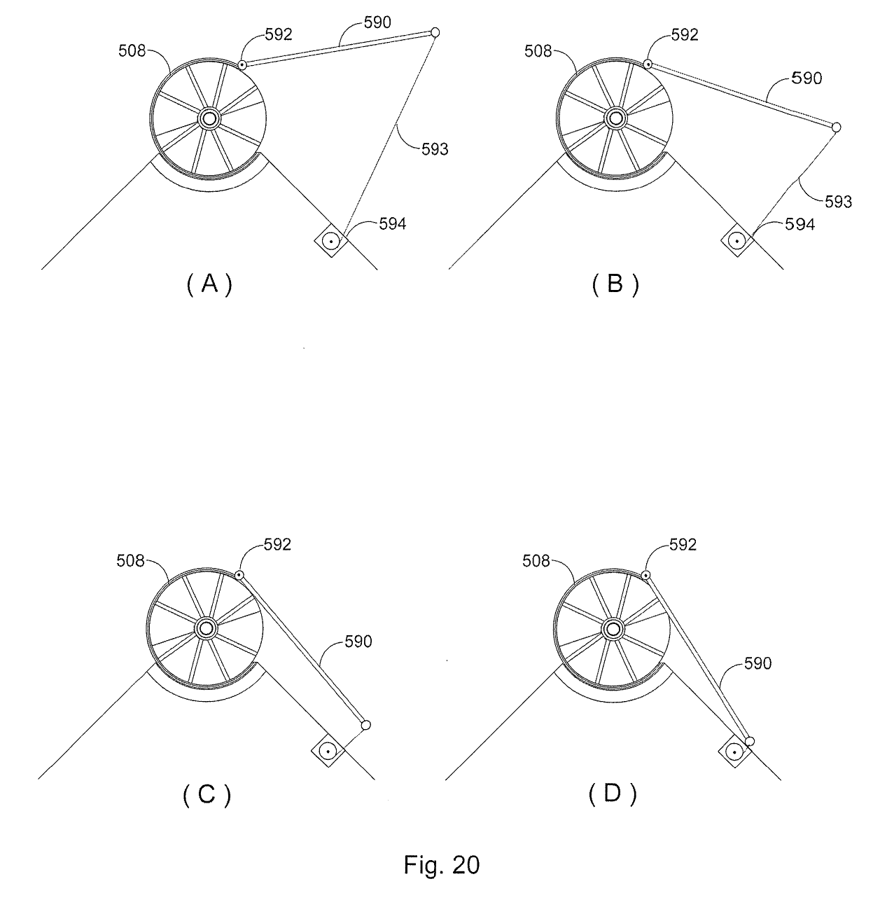

FIG. 20 illustrates an airflow guide 590 connected by a hinge to collector 508. A line 593 is connected to an end of the airflow guide 590, and to a takeup spool 594. The takeup spool 594 can include an electric motor for electrical operation, or a mechanical motor for mechanical operation. The line 593 is preferably metal, but can be nylon or other synthetic material. The angle of the airflow guide 590 is adjustable for various conditions for maximizing wind energy collection or safety. For instance, FIG. 20A shows the airflow guide 590 in a fully open configuration for low wind conditions, and FIG. 20B shows the airflow guide 590 in a partially open configuration for normal operations, i.e. angled toward the collector inlet yet close to parallel to a surface of the structure. FIG. 20C shows the airflow guide in a partially open configuration for high wind operations, i.e. angled toward the structure yet close to parallel to the surface of the structure. If a gust of wind occurs, it will push airflow guide 590 down to the closed position shown in FIG. 20D, which shows the airflow guide in a closed configuration in a protective mode, in which the airflow guide 590 is completely closed and can abut the wind turbine blades to prevent the rod from spinning.

The lateral wind turbine system described herein is specifically designed for collecting wind that is gathered by the surface of the structure. By mounting the lateral wind turbine assembly and collector at the optimal place on the structure where most of the wind energy has gathered, the efficiency of translating ambient airflow into rotational energy is increased.

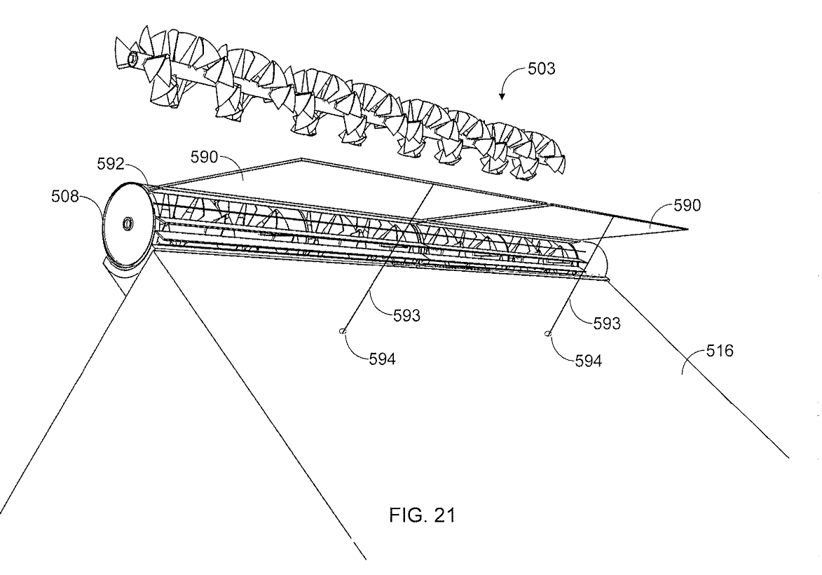

FIG. 21 is a plan view of a wind turbine assembly 503 and a collector 508 as described with respect to FIGS. 20A-B, and mounted on a roofline via one or more mounting bracket. The collector 508 includes an airflow guide 590 that is biased to an open configuration by hinge 592, yet closable to a closed configuration by line 593 coupled to spool 594. A wind sensor (not shown) can be placed anywhere along surface of a structure 516, and preferably close to the wind turbine assembly 503, to sense and determine wind speed to control the angle of the airflow guide 590.

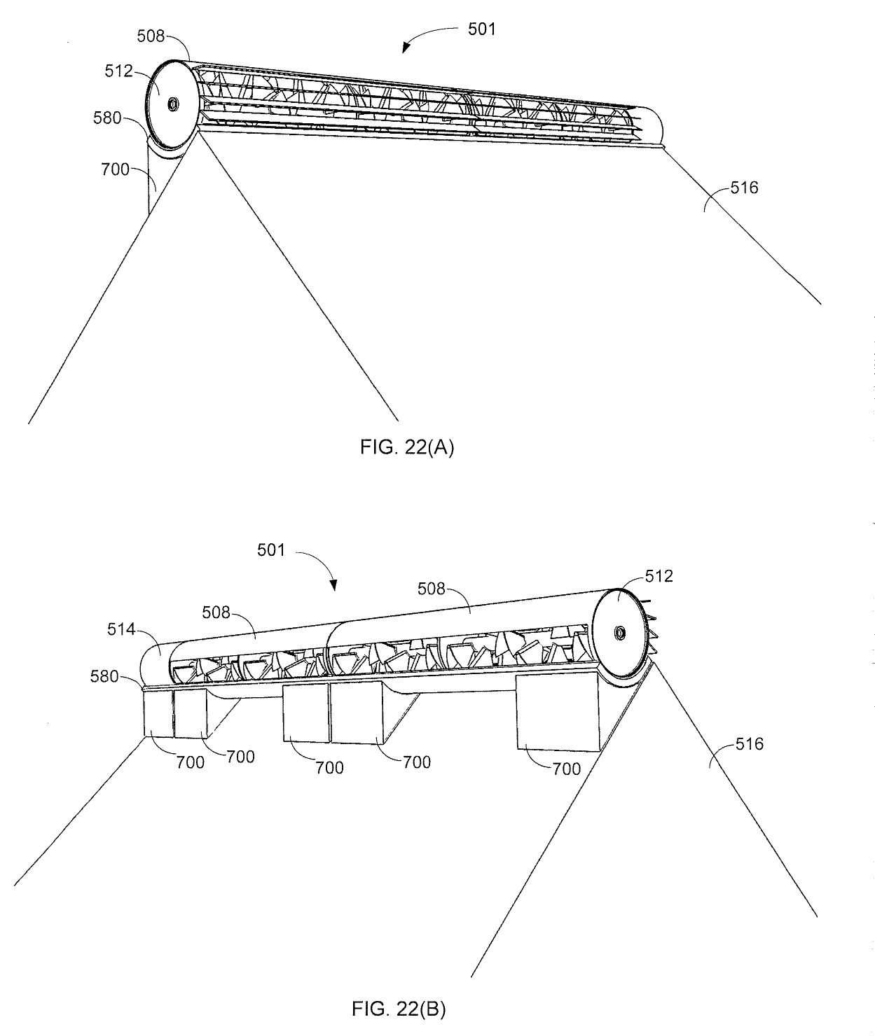

FIG. 22A is a front plan view and FIG. 22B is a rear plan view of a lateral wind turbine system 501 having a collector 508 that includes two or more airflow guides at an inlet, and which is mounted to a structure 516 via one or more mounts 700. The mounts 70 can include physical attachment mechanisms such as screws, bolts, glue, etc., and can also include electrical conduits for connecting the lateral wind turbine system 501 to an energy consumer device.

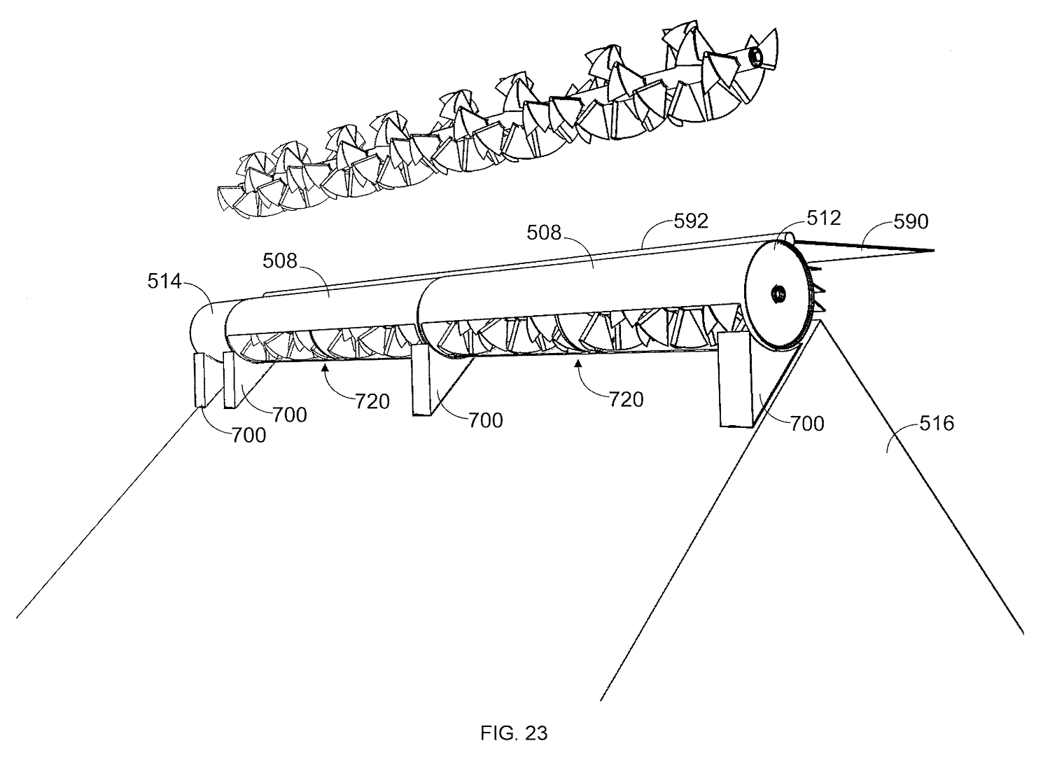

FIG. 23 shows yet another alternative implementation, in which one or more helical wind turbine assemblies 503 are mounted in corresponding number of collectors 508, one of which is connected to a generator assembly 514, and mounted to a structure 516. In this implementation, the assembled lateral wind turbine system 501 is mounted to the structure on one or more mounting brackets 700. An outlet 720 of the collector is extended to occupy approximately one-quarter of the circumferential area of the collector, and facing downward onto the structure. At the inlet side, one or more airflow guides 590, of the same or varying size, are provided to direct airflow to the blades of the wind turbine assemblies for maximum rotational energy.

Various devices, techniques and systems have been described in which lateral wind turbines can be beneficially employed. Although a few embodiments have been described in detail above, other modifications are possible. For example, each lateral wind turbine can include a control system having circuitry or logic to control various aspects of the turbine, such as: power control to automatically adjusts the pitch of the blades based on wind speeds; feedback to indicate rotor speed and/or electric energy output, etc. Other embodiments may be within the scope of the following claims.

What is claimed:

1. A lateral wind turbine for mounting on an edge of a structure, the wind turbine comprising:
an elongated rod that rotates about a rotation axis through the center of the rod;
a plurality of blades radiating out from the rod in an arrangement along the length of the rod and adapted to capture wind energy that is at least partially transverse to the rotation axis;
a bearing coupled to a distal end of the rod; and
a generator coupled to a proximal end of the rod.

2. A lateral wind turbine in accordance with claim 1, further comprising a housing adapted to cover the rod and plurality of blades, and having an inlet and an outlet to allow airflow over one side of the rod.

3. A lateral wind turbine in accordance with claim 1, wherein the arrangement of the plurality of blades is a helical arrangement along the length of the rod.

4. A lateral wind turbine in accordance with claim 1, wherein each of the plurality of blades is triangular.

5. A lateral wind turbine in accordance with claim 2, wherein the distal end of the rod is rotatably mounted to an end of the housing.

6. A lateral wind turbine in accordance with claim 5, further comprising a bearing that mounts the distal end of the rod to the end of the housing.

7. A lateral wind turbine in accordance with claim 5, further comprising a magnetic inductor that mounts the distal end of the rod to the end of the housing.

8. A lateral wind turbine in accordance with claim 1, wherein the generator is adapted to convert rotational motion of the rod into electricity.

9. A lateral wind turbine in accordance with claim 1, wherein the rod and the plurality of blades are formed of a unitary material.

10. A lateral wind turbine in accordance with claim 1, wherein the plurality of blades are dynamically tunable to one of a range of angular pitches with respect to the rod.

11. A lateral wind turbine, comprising:
an elongated housing with a rotation axis and including an outer surface having an inlet and an outlet, the inlet and outlet defining an airflow passageway that is transverse to the rotation axis;
a rod mounted within the elongated housing and configured to rotate about the rotation axis;
a plurality of blades radiating out from the rod along the rotation axis and configured to capture wind energy traveling through the airflow passageway; and
a generator coupled to a proximal end of the rod.

12. A lateral wind turbine in accordance with claim 11, wherein the elongated housing is substantially cylindrical.

13. A lateral wind turbine in accordance with claim 11, wherein the generator is connected to the housing.

14. A lateral wind turbine in accordance with claim 11, wherein a distal end of the rod is rotatably mounted to an inner end of the housing.

15. A power generation system comprising:
a structure; and
one or more lateral wind turbines mounted along an edge of the structure, each lateral wind turbine comprising:
a rotor assembly having a rod that rotates about a rotation axis and a plurality of blades radiating out from the rod along the rotation axis and arranged to capture wind energy that is transverse to the rotation axis; and
a power generator coupled to a proximal end of the rotor assembly.

16. A power generation system in accordance with claim 15, further comprising a cylindrical housing over the rotor assembly and having a surface that is adapted to allow transverse airflow into an inlet, over at least a portion of the rotor assembly, and out through an outlet for passage.

17. A power generation system in accordance with claim 15, wherein two or more lateral wind turbines are connected in series along the edge of the structure.

18. A method of generating electricity comprising:
placing a lateral wind turbine at an edge of a structure where wind energy is concentrated and accelerated, the lateral wind turbine comprising:
an elongated rod that rotates about a rotation axis through the center of the rod;
a plurality of blades radiating out from the rod in an arrangement along the length of the rod and adapted to capture wind energy that is at least partially transverse to the rotation axis;
a bearing coupled to a distal end of the rod; and
a generator coupled to a proximal end of the rod; and
generating electricity from the concentrated and accelerated wind energy using the elongated lateral rotating wind turbine.

19. A method in accordance with claim 18, wherein the edge of the structure is a roofline of the structure.

20. A method in accordance with claim 18, further comprising connecting one end of a first lateral wind turbine onto one end of a second lateral wind turbine.

21. An apparatus, comprising:
a housing covering an elongated rotor, the elongated rotor having a plurality of radially-extending blades, the housing further including a passageway that is transverse to an axis of rotation of the rotor to allow airflow through the radially-extending blades at least partially laterally to a rotation axis of the rotor to rotate the rotor.

22. An apparatus in accordance with claim 21, further comprising a generator connected to the elongated rotor to generate electricity from rotation of the rotor.

23. An apparatus, comprising:
a cylindrical housing having a rotation axis and an airflow passageway that is transverse to the rotation axis; and
means, mounted in the cylindrical housing, for converting wind energy through the airflow passageway into rotary energy defined by a rotation axis that is transverse to a direction of the wind energy; and
a generator connected with the converting means for converting the rotary energy into electricity.

24. A clean, renewable energy system, comprising:
a structure having at least one surface;
one or more lateral wind turbines connected along an edge of the surface to convert wind energy concentrated on and accelerated by the at least one surface toward the edge, the one or more lateral wind turbines adapted to convert the wind energy into electricity; and
one or more solar panels arranged on the at least one surface to convert solar energy into heat and/or electricity.

25. A clean, renewable energy system in accordance with claim 25, wherein each of the one or more lateral wind turbines includes:
an elongated housing with a rotation axis and including an outer surface having an inlet and an outlet, the inlet and outlet defining an airflow passageway that is transverse to the rotation axis;
a rod mounted within the elongated housing and configured to rotate about the rotation axis;
a plurality of blades radiating out from the rod along the rotation axis and configured to capture wind energy traveling through the airflow passageway; and
a generator coupled to a proximal end of the rod.

26. A clean, renewable energy system in accordance with claim 25, wherein each of the one or more solar panels includes an array of photovoltaic cells.

27. A wind turbine comprising:
one more wind turbine segments, each wind turbine segment comprising:
an elongated rod that rotates about a rotation axis through the center of the rod; and
a plurality of blades radiating out from the rod in an arrangement along the length of the rod to capture wind energy that is at least partially transverse to the rotation axis; and
a wind collector that at least partially houses each of the one or more wind turbine segments, the wind collector having an inlet and an outlet, and at least one airflow guides at the inlet, each wind collector supporting at least one wind turbine segment in a rotational arrangement.

28. A wind turbine comprising:
an elongated rod that rotates about a rotation axis through the center of the rod; and
a plurality of blades radiating out from the rod in an arrangement along the length of the rod to capture wind energy; and
a wind collector that at least partially houses and supports the elongated rod and the plurality of blades to allow rotation of the elongated rod about the rotation axis, the wind collector having an inlet an outlet, and at least one airflow guide at the inlet, to guide the wind energy through the plurality of blades at least partially transverse to the rotation axis.

29. The wind turbine of claim 28, wherein each of the plurality of blades includes a V-shaped blade surface.

30. The wind turbine of claim 28, wherein the arrangement of the plurality of blades is helical.

31. A wind turbine comprising:
an cylindrical collector having an inlet and an outlet along a length of the cylindrical collector;
a wind turbine assembly rotatably mounted in the cylindrical collector and configured to spin around a rotation axis through the length of the cylindrical collector, the wind turbine assembly comprising a rod having a distal end mounted to a first end of the cylindrical collector by a bearing, the rod having a proximal end connected to a drive shaft of a device that converts rotational energy of the wind turbine assembly into electricity, the wind turbine assembly further including a plurality of blades extending radially from the rod in an arrangement along the length of rod to capture wind energy that has a direction that is transverse to the length of the cylindrical collector to rotate the wind turbine assembly.

32. The wind turbine in accordance with claim 31, wherein the device that converts rotational energy of the wind turbine assembly is selected from a group of devices that consists of: a generator, a compressor, an alternator, and an inverter.

33. The wind turbine in accordance with claim 31, wherein the arrangement of the plurality of blades is a helix along the rod.

34. The wind turbine in accordance with claim 31, wherein the cylindrical collector further includes one or more airflow guides connected to the cylindrical collector proximate the inlet.

35. The wind turbine in accordance with claim 34, wherein each of the one or more airflow guides includes a pitch relative to the length of the cylindrical collector that is independently adjustable.
